(19) United States
(12) Patent Application Publication
(10) Pub. No.: US 2019/0250967 A1
(43) Pub. Date: Aug. 15, 2019

(54) METHOD AND SYSTEM FOR OPENING A DATA OBJECT

(71) Applicant: RES SOFTWARE DEVELOPMENT B.V., 'S-Hertogenbosch (NL)

(72) Inventors: Bob JANSSEN, Breda (NL); Henricus Adrianus van Bommel, Someren (NL); Reinhard Peter BRONGERS, Breda (NL); Julio Ramon Garcia Perez, Toledo (ES)

(73) Assignee: RES SOFTWARE DEVELOPMENT B.V., 'S-Hertogenbosch (NL)

(21) Appl. No.: 16/324,829

(22) PCT Filed: Jun. 20, 2016
(86) PCT No.: PCT/EP2016/064190

§ 371 Date: Feb. 11, 2019

(51) Int. Cl. G06F 9/54; G06F 16/955; G06F 16/958

(52) U.S. Cl. CPC G06F 9/548; G06F 16/986; G06F 16/955

(57) ABSTRACT

The invention relates to a method of opening a data object, e.g. a web page, that involves detecting an instruction to open the data object, e.g. by using network packet inspection, determining a unique identifier of the data object, looking up a recommended application, e.g. a certain web browser, for the data object in a mapping (21) from data object identifier (23) to application identifier (25), and opening the data object with the recommended application.

### FIELD OF THE INVENTION

The invention relates to a method of opening a data object, e.g. a web page.

The invention further relates to a system for opening a data object.

The invention also relates to a computer program product enabling a computer system to perform such a method.

### BACKGROUND OF THE INVENTION

The World Wide Web is one of the most popular applications of the Internet. Web pages on the World Wide Web are either static or generated dynamically by web applications. Web pages are often encoded using HyperText Markup Language (HTML), Cascading Style Sheets (CSS) and Javascript. Many different makes and versions of web browsers that are able to decode web pages exist. When a developer/creator develops a static webpage or a web application, he usually tests it with a few different makes and versions of web browsers and often targets one specific make of web browser. As a result, more and more web pages, especially legacy web applications, require a specific web browser make and version. Users typically choose one favorite web browser and use that web browsers for all the web pages that they visit/open.

A drawback of the existing manner in which users use a web browser to open a web page is that they regularly only experience the opened web page as intended by their creator if the opened web page happens to be tested with the make and version of the web browser that they are using.

### SUMMARY OF THE INVENTION

It is a first object of the invention to provide a method of opening a data object, which allows more opened data objects to be experienced as intended by their creator.

It is a second object of the invention to provide a system for opening a data object, which allows more opened data objects to be experienced as intended by their creator.

According to the invention, the first object is realized in that the method of opening a data object comprises the steps of a processor detecting an instruction to open a data object, a processor determining an identifier of said data object (e.g. at least part of a website address), a processor looking up a recommended application identifier in a mapping from data object identifier to application identifier, said recommended application identifier identifying an application associated with said identifier of said data object, and a processor opening said data object with said application identified by said recommended application identifier.

The method may be performed by software running on a programmable device. This software may be provided as a computer program product. The identifier of the data object may be unique. The mapping may comprise a plurality of at least partial web site addresses (e.g. URLs), each of the plurality of at least partial web site addresses being mapped to an application identifier and the application identifier identifying a web browser.

The inventor has recognized that by maintaining and using a mapping from data object identifier to application identifier and determining a recommended application for opening a data object (e.g. a web page) based on this mapping, the application (e.g. web browser) that is used to open a data object can be made dependent on the data object. An application for which the creator of the data object intended the data object or with which the creator tested the data object can be associated with the data object in the mapping in order to allow more opened data objects to be experienced as intended by their creator.

The step of said processor opening said data object with said application may comprise the steps of determining whether said application identified by said recommended application identifier is the same as an application in which said instruction is detected, passing on said instruction to said application in which said instruction is detected if said applications are the same and creating a new instruction for said application identified by said recommended application identifier if said applications are not the same. This allows the instruction to be detected within the application. For example, when a (e.g. textual or graphical) link is clicked on a web page, normally the web browser process replaces the current web page with a web page, adds a new tab or spawns a new browser process (typically resulting in a new window with the new web page as only tab). If the current web browser is not the recommended web browser for the URL associated with the link, the normal action taken by the current web browser may be intercepted and the recommended web browser may requested to open the web page at the URL associated with the link.

The step of said processor detecting an instruction to open a data object may comprise the step of a web browser plug-in executed by said processor detecting said instruction. Use of a plug-in may be able to prevent that the current web browser is waiting for a web page to open, while the instruction to open the web page (e.g. an http GET request) has been intercepted and another web browser has opened the web page instead.

The step of said processor detecting an instruction to open a data object may comprise the step of inspecting network packets. The advantage of this solution is that it works in most situations, e.g. when a web browser does not support plug-ins or when there are other ways of opening web page that bypass a plug-in.

Said processor detecting an instruction to open a data object may comprise detecting an instruction to open a file and the method may further comprise the steps of determining whether said application identified by said recommended application identifier is the same as an application associated with a file type of said file and preventing said file from being opened with said application associated with said file type of said file if said applications are not the same. This allows the instruction to be detected outside the application. For example, when a file/shortcut to a web page is opened from a folder, from a desktop, from a taskbar or from a start menu, typically the website address/URL will be provided to the already running or to be started browser process of the browser associated with the type of the file. If this browser is not the recommended application, this may be prevented and the website address/URL may be provided to an already running or to be started process of the recommended browser instead.

According to the invention, the second object is realized in that the system for opening a data object comprises a storage facility for storing a mapping from data object identifier to application identifier and at least one processor configured to detect an instruction to open a data object, to determine an identifier of said data object (e.g. at least part of a website address), to look up a recommended application identifier in said mapping stored on said storage facility, said recommended application identifier identifying an application associated with said identifier of said data object, and to open said data object with said application identified by said recommended application identifier.

Said mapping may comprise a plurality of at least partial web site addresses, each of said plurality of at least partial web site addresses being mapped to an application identifier and said application identifier identifying a web browser.

Said at least one processor may be configured to detect said instruction within an application. Said at least one processor may be configured to determine whether said application identified by said recommended application identifier is the same as said application in which said instruction is detected, to pass on said instruction to said application in which said instruction is detected if said applications are the same and to create a new instruction for said application identified by said recommended application identifier if said applications are not the same. Said at least one processor may be configured to detect said instruction by inspecting network packets. Said at least one processor may be configured to use a web browser plug-in to detect said instruction.

Said at least one processor may be configured to detect said instruction outside an application. Said at least one processor may be configured to detect an instruction to open a file, to determine whether said application identified by said recommended application identifier is the same as an application associated with a file type of said file and to prevent said file from being opened with said application associated with said file type of said file if said applications are not the same.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: detecting an instruction to open a data object, determining an identifier of said data object, looking up a recommended application identifier in a mapping from data object identifier to application identifier, said recommended application identifier identifying an application associated with said identifier of said data object, and opening said data object with said application identified by said recommended application identifier.

As will be appreciated by one skilled in the art, aspects of the present invention may be embodied as a system, a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of the invention;

FIG. 2 is a flow diagram of a second embodiment of the method of the invention;

FIG. 3 is a flow diagram of a third embodiment of the method of the invention;

FIG. 4 shows an example of a mapping used in an embodiment of the method of the invention;

FIG. 5 shows a user interface provided in an embodiment of the method of the invention;

FIG. 6 shows a user interface provided in a further embodiment of the method of the invention;

FIG. 7 is a block diagram of a first embodiment of the system of the invention;

FIG. 8 is a block diagram of a second embodiment of the system of the invention; and

FIG. 9 is a block diagram of an exemplary data processing system for performing the method of the invention.

Corresponding elements in the drawings are denoted by the same reference numeral.

### DETAILED DESCRIPTION OF THE DRAWINGS

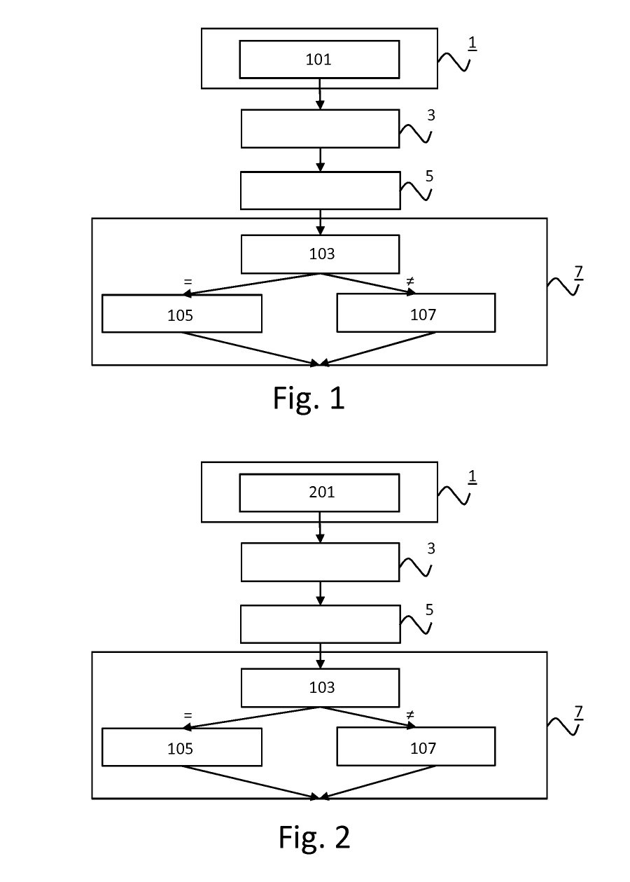

A first embodiment of the method opening a data object of the invention is shown in FIG. 1. A step 1 comprises a processor detecting an instruction to open a data object. A step 3 comprises a processor determining an identifier of the data object. A step 5 comprises a processor looking up a recommended application identifier in a mapping from data object identifier to application identifier, the recommended application identifier identifying an application associated with the identifier of the data object. A step 7 comprises a processor opening the data object with the application identified by the recommended application identifier.

In the first embodiment, the instruction is detected within an application. Step 7 comprises three sub steps. A step 103 comprises determining whether the application identified by the recommended application identifier is the same as the application in which the instruction is detected. A step 105 comprises passing on the instruction to the application in which the instruction is detected if the applications are the same. A step 107 comprises creating a new instruction for the application identified by the recommended application identifier if the applications are not the same. In the first embodiment, step 1 comprises a step 101 of inspecting network packets.

A second embodiment of the method opening a data object is shown in FIG. 2. In the second embodiment, the instruction is also detected within an application. Compared to the first embodiment shown in FIG. 1, step 101 has been replaced with a step 201 of a web browser plug-in executed by the processor detecting the instruction.

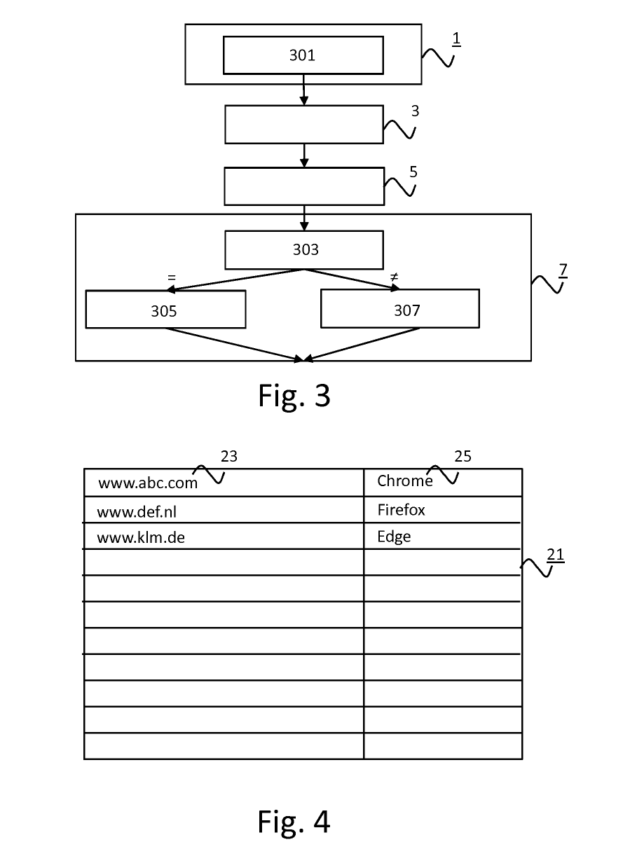

A third embodiment of the method opening a data object is shown in FIG. 3. In the third embodiment, the instruction is detected outside an application. In the third embodiment, step 1 comprises a step 301 of detecting an instruction to open a file and step 7 comprises three sub steps. A step 303 comprises determining whether the application identified by the recommended application identifier is the same as an application associated with a file type of the file. A step 307 comprises opening the file with the application identified by the recommended application identifier and preventing the file from being opened with the application associated with the file type of the file if the applications are not the same. A step 305 comprises opening the file with the application associated with the file type of the file if the applications are the same.

FIG. 4 shows an example of a mapping used in an embodiment of the method of the invention. In this embodiment, the identifier of the data object comprises at least part of a website address. The mapping 21 comprises a plurality of at least partial web site addresses 23. Each of the plurality of at least partial web site addresses 23 is mapped to an application identifier 25. The application identifier 25 identifies a web browser. The application identifier 25 may comprise an application name or a file name (with or without a path to the file), for example. In FIG. 4, the shown website addresses are the addresses of web servers and the same web browser is used for all URLs that start with this web server address (e.g. for “www.abc.com/index_en.html” and “www.abc.com/index_nl.html”). It may also be possible to specify multiple webservers in one entry, e.g. “*.abc.com”. In this case, the same web browser might be used for all web servers in the abc.com domain (e.g. “www.abc.com” and “portal.abc.com”).

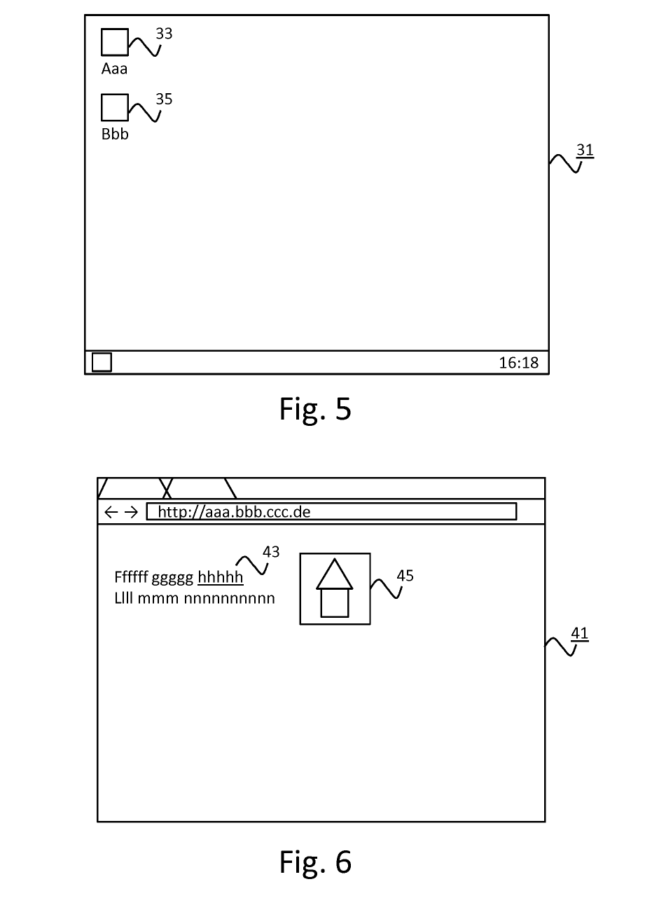

FIG. 5 shows a user interface provided in an embodiment of the method of the invention. Screen 31 shows a desktop with a first icon 33 and a second icon 35. The first icon 33 is associated with a file representing a short cut to an application, e.g. an e-mail application. The second icon 35 is associated with a file representing a shortcut to a web page, which comprises an URL. When the second icon 35 is activated, e.g. by double clicking it with a mouse or tapping it on a touch screen, it is determined with which application the type of the file (e.g. .URL) has been associated. In the Windows operating system, this may be performed by a process kernel driver on executing a ‘shellexecute’ function on an .URL type of file.

If this application is the recommended application for the URL stored in the file associated with the second icon 35, this application is started if not already running and is provided the URL. If not, this application is not provided the URL and is not started if not already running. Instead, the recommended application is started if not already running and provided the URL.

FIG. 6 shows a user interface provided in a further embodiment of the method of the invention. Screen 41 shows a web browser with two tabs. In the currently active tab, a web page with a textual link 43 and a graphical link 45 is shown. When the textual link 43 or the graphical link 45 is selected, the URL corresponding to the link is inspected and it is determined what the recommended application for this URL is. If the current web browser is the recommended application for this URL, the web browser process is allowed to continue and open the web page located at the inspected URL. If the current web browser is not the recommended application for this URL, the web browser process is prevented from opening the web page located at the inspected URL and the URL is passed on to the recommended application. If the recommended application is currently not running, i.e. no process exists for the recommended application, a new process is started for the recommended application.

Preventing the web browser process from opening the web page located at the inspected URL may be performed by a network kernel driver that intercepts and identifies outgoing web page requests (e.g. HTTP GET requests) and the corresponding processes, i.e. a network kernel driver that performs network packet inspection, or by a browser plugin before navigating to a (different) web page. The process of the current web browser may be redirected to another URL, e.g. of an Intranet web page. The current web browser may show a blank page or a page with a custom error message instead of the web page located at the inspected URL, for example. If a network kernel driver is used to prevent the web browser process from opening the web page located at the inspected URL, then it may be necessary to redirect the current web browser to another URL in order to show a blank page or a page with a custom error message.

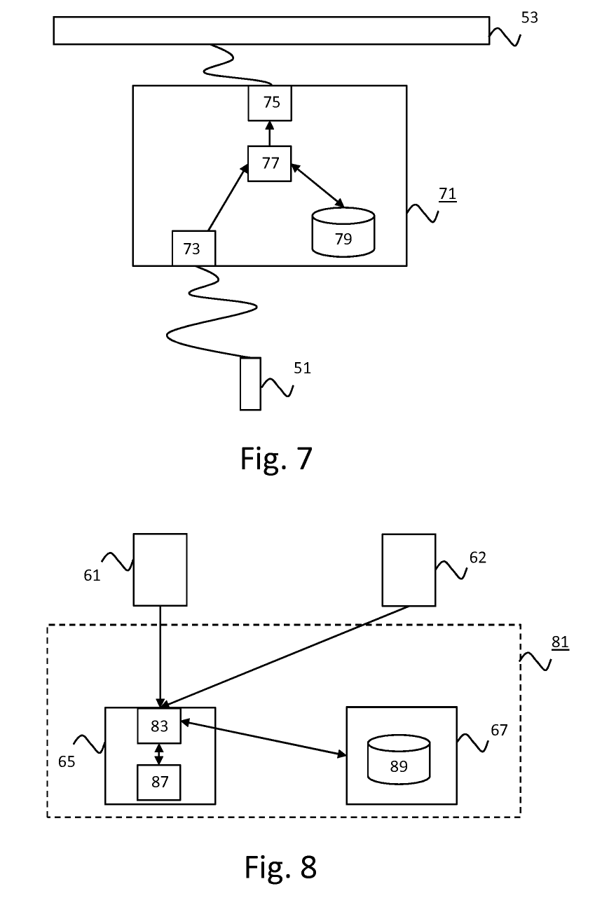

A first embodiment of the system for opening a data object of the invention is shown in FIG. 7. The system 71 comprises a storage facility 79 for storing a mapping from data object identifier to application identifier and a processor 77. The processor 77 is configured to detect an instruction to open a data object, to determine an identifier of the data object and to look up a recommended application identifier in the mapping stored on the storage facility 79. The recommended application identifier identifies an application associated with the identifier of the data object. The processor 77 is further configured to open the data object with the application identified by the recommended application identifier.

The system 71 may comprise a personal computer, e.g. a desktop computer or a laptop computer, for example. The system 71 may run a Windows, Unix-like or OS X operating system, for example. The processor 77 may comprise an Intel or AMD processor, for example. The storage facility 79 may comprise multiple storage components. The storage facility 79 may comprise a solid-state (e.g. RAM or flash), optical and/or magnetic storage means, for example. The mapping may be stored in a file or in a database on the storage facility 79, for example. The system 71 further comprises an interface 73 for receiving a user command to open the data object. The interface 73 is coupled to an input device 51, e.g. a mouse. This coupling may be wired or wireless, for example. The interface 73 may be a USB connector, for example. The system 71 further comprises a display interface 75, e.g. an HDMI, VGA or DisplayPort connector. The display interface 75 is coupled to a display 53, e.g. a monitor or TV, by wire. Alternatively, a display 53 may be coupled to the system 71 wirelessly, e.g. via a BlueTooth or WiFi (IEEE 802.11) connection.

In the system 71, the recommended application is determined and executed locally by the processor 77. The applications identified in the mapping are also stored locally on the storage facility 79.

A second embodiment of the system for opening a data object of the invention is shown in FIG. 8. The system 81 comprises an application server 65 and a storage server 67. The application server 65 comprises a processor 87. The storage server 67 comprises a storage facility 89. The processor 87 is configured to detect an instruction to open a data object, to determine an identifier of the data object and to look up a recommended application identifier in the mapping stored on the storage facility 89. The recommended application identifier identifies an application associated with the identifier of the data object. The processor 87 is further configured to open the data object with the application identified by the recommended application identifier. The application server 65 may be similar to the application server described in U.S. Pat. No. 7,725,527, for example.

The application server 65 and the storage server 67 may run a Windows and/or Unix (or Unix-like) operating system, for example. The processor 87 may comprise an Intel or AMD processor, for example. The storage facility 89 may comprise multiple storage components. The storage facility 89 may comprise a solid-state (e.g. RAM or flash), optical and/or magnetic storage means, for example.

The application server 65 further comprises an interface 83. The interface 83 may comprise a wireless and/or wired network interface, e.g. Ethernet or WiFi. The interface 83 is coupled to a first terminal 61, a second terminal 62 and the storage server 67. The mapping and the applications identified in the mapping are stored on the storage facility 89 of the storage server 67. The applications execute on the processor 87 of the application server 65, which transmits display data to the first terminal 61 and the second terminal 62 over the interface 83. When a user uses first terminal 61 or second terminal 62 to open a data object on the application server 65, e.g. from a web browser running on the application server 65 or from a remote desktop hosted by the application server 65, the data object is opened by the recommended application on the application server 65.

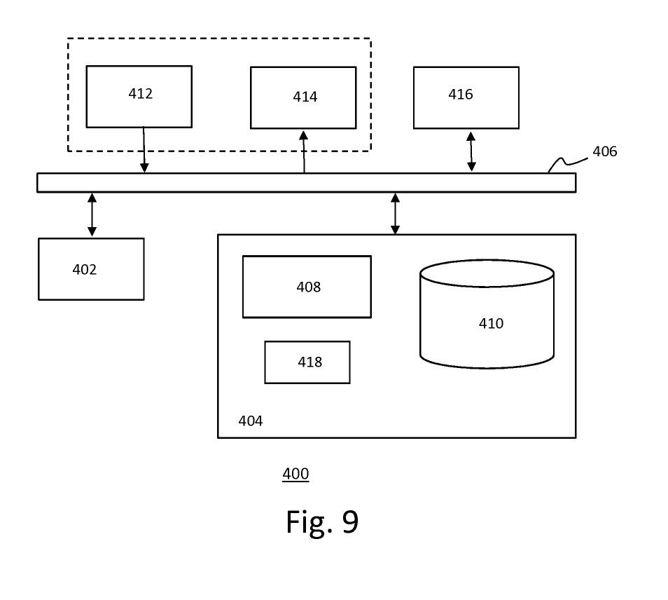

FIG. 9 depicts a block diagram illustrating an exemplary data processing system that may perform the methods as described with reference to FIGS. 1 to 3.

As shown in FIG. 9, the data processing system 400 may include at least one processor 402 coupled to memory elements 404 through a system bus 406. As such, the data processing system may store program code within memory elements 404. Further, the processor 402 may execute the program code accessed from the memory elements 404 via a system bus 406. In one aspect, the data processing system may be implemented as a computer that is suitable for storing and/or executing program code. It should be appreciated, however, that the data processing system 400 may be implemented in the form of any system including a processor and a memory that is capable of performing the functions described within this specification.

The memory elements 404 may include one or more physical memory devices such as, for example, local memory 408 and one or more bulk storage devices 410. The local memory may refer to random access memory or other non-persistent memory device(s) generally used during actual execution of the program code. A bulk storage device may be implemented as a hard drive or other persistent data storage device. The processing system 400 may also include one or more cache memories (not shown) that provide temporary storage of at least some program code in order to reduce the number of times program code must be retrieved from the bulk storage device 410 during execution.

Input/output (I/O) devices depicted as an input device 412 and an output device 414 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 412 and the output device 414). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 416 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 400, and a data transmitter for transmitting data from the data processing system 400 to said systems, devices and/or networks. Modems, cable modems, and Ethernet cards are examples of different types of network adapter that may be used with the data processing system 400.

As pictured in FIG. 9, the memory elements 404 may store an application 418. In various embodiments, the application 418 may be stored in the local memory 408, the one or more bulk storage devices 410, or separate from the local memory and the bulk storage devices. It should be appreciated that the data processing system 400 may further execute an operating system (not shown in FIG. 9) that can facilitate execution of the application 418. The application 418, being implemented in the form of executable program code, can be executed by the data processing system 400, e.g., by the processor 402. Responsive to executing the application, the data processing system 400 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 402 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of opening a data object, comprising the steps of:
a processor detecting an instruction to open a data object;
a processor determining an identifier of said data object;
a processor looking up a recommended application identifier in a mapping from data object identifier to application identifier, said recommended application identifier identifying an application associated with said identifier of said data object; and
a processor opening said data object with said application identified by said recommended application identifier.

2. The method of claim 1, wherein said identifier of said data object comprises at least part of a website address.

3. The method of claim 2, wherein said mapping comprises a plurality of at least partial web site addresses, each of said plurality of at least partial web site addresses being mapped to an application identifier and said application identifier identifying a web browser.

4. The method of claim 1, wherein said instruction is detected within an application.

5. The method of claim 4, wherein the step of said processor opening said data object with said application comprises the steps of determining whether said application identified by said recommended application identifier is the same as said application in which said instruction is detected, passing on said instruction to said application in which said instruction is detected if said applications are the same and creating a new instruction for said application identified by said recommended application identifier if said applications are not the same.

6. The method of claim 4, wherein the step of said processor detecting an instruction to open a data object comprises the step of inspecting network packets.

7. The method of claim 4, wherein the step of said processor detecting an instruction to open a data object comprises the step of a web browser plug-in executed by said processor detecting said instruction.

8. The method of claim 1, wherein said instruction is detected outside an application.

9. The method of claim 8, wherein the step of said processor detecting an instruction to open a data object comprises detecting an instruction to open a file and further comprising the steps of determining whether said application identified by said recommended application identifier is the same as an application associated with a file type of said file and preventing said file from being opened with said application associated with said file type of said file if said applications are not the same.

10. (canceled)

11. A system for opening a data object, comprising:
a storage facility for storing a mapping from data object identifier to application identifier; and
at least one processor configured to detect an instruction to open a data object, to determine an identifier of said data object, to look up a recommended application identifier in said mapping stored on said storage facility, said recommended application identifier identifying an application associated with said identifier of said data object, and to open said data object with said application identified by said recommended application identifier.

12. The method of claim 11, wherein said mapping comprises a plurality of at least partial web site addresses, each of said at least partial plurality of web site addresses being mapped to an application identifier and said application identifier identifying a web browser.

13. The method of claim 11, wherein said at least one processor is configured to determine whether said application identified by said recommended application identifier is the same as said application in which said instruction is detected, to pass on said instruction to said application in which said instruction is detected if said applications are the same and to create a new instruction for said application identified by said recommended application identifier if said applications are not the same.

14. The method of claim 11, wherein said at least one processor is configured to detect an instruction to open a file, to determine whether said application identified by said recommended application identifier is the same as an application associated with a file type of said file and to prevent said file from being opened with said application associated with said file type of said file if said applications are not the same.
